(19) United States
(12) Patent Application Publication
(10) Pub. No.: US 2018/0054574 A1
(43) Pub. Date: Feb. 22, 2018

(54) NOISE REDUCTION UNIT INCLUDED IN SENSOR ARRAY OF MULTI APERTURE CAMERA, AND OPERATION METHOD THEREFOR

(71) Applicant: CENTER FOR INTEGRATED SMART SENSORS FOUNDATION, Daejeon (KR)

(72) Inventors: Jong Ho Park, Daejeon (KR); Sang Jin Lee, Daejeon (KR)

(21) Appl. No.: 15/555,538

(22) PCT Filed: Mar. 4, 2015
(86) PCT No.: PCT/KR2015/002087

§ 371 Date: Sep. 4, 2017

(51) Int. Cl. H04N 5/357; H04N 5/378; H04N 9/04

(52) U.S. Cl. CPC H04N 5/357; H04N 9/045; H04N 5/378

(57) ABSTRACT

A noise reduction unit included in a sensor array of a multi aperture camera comprises: at least one programmable gain amplifier (PGA) that outputs a difference value between a reset voltage for at least one pixel included in the sensor array and a signal voltage for the at least one pixel, and/or respective values, as an analog signal for the at least one pixel; and at least one AD converter that converts the outputted analog signal for the at least one pixel to a digital signal for the at least one pixel and outputs the digital signal, wherein the at least one AD converter performs an over-sampling operation that samples the output signal of the at least one PGA for the at least one pixel multiple times and/or an averaging operation that calculates an average value for output signal of the at least one PGA which has been sampled multiple times.

### TECHNICAL FIELD

The present invention relates a technology for a noise canceller unit included in a sensor array of a multi aperture camera, and more particularly, to a technology for a unit improving sensitivity by cancelling noise in a signal processed in at least one pixel included in a sensor array.

### BACKGROUND ART

A multi aperture camera includes a plurality of apertures and acquires a plurality of images by processing optical signal passing through each of the plurality of apertures (e.g., an aperture for introducing a RGB signal and a cut-off filter for introducing an IR signal) in a plurality of sensor array.

Particularly, the sensor array of the multi aperture camera acquires a blurred image for extracting distance information from RGB (Red-Green-Blue) pixels and acquires a sharp image that becomes standard from an IR pixel by including the RGB pixels and the IR pixel.

Here, because the IR pixel inputs an IR signal as an optical input introduced through a small aperture of a cut-off filter included in the multi aperture camera, the IR pixel has a disadvantage that an input signal is reduced compared to the RGB pixels inputting an optical signal introduced through a big aperture and a signal-to-noise ratio for the IR signal is small.

Also, in a three color multi aperture method for being configured with only RGB pixels and extracting distance information, because an R pixel inputs an R signal as an optical input introduced through a small aperture of a cut-off filter, the R pixel has a disadvantage that an input signal is reduced compared to the GB pixels inputting optical signal introduced through a big aperture and a signal-to-noise ratio for the R signal is small.

Accordingly, this description proposes a technology improving a signal-to-noise ratio of a signal processed from at least one pixel by cancelling (reducing) noise from the signal processed from the at least one pixel included in a sensor array.

Also, this technology may be used to a high sensitivity sensor improving a signal-to-noise ratio by cancelling noise of all output when applied to all signals of RGB and IR.

### DETAILED DESCRIPTION OF THE INVENTION

### Technical Problem

Embodiments of the present invention provide a noise canceller unit improving a signal-to-noise ratio of a signal processed from at least one pixel and an operation method thereof by cancelling noise from the signal processed from the at least one signal included in a sensor array.

Particularly, embodiments of the present invention provide a high sensitivity unit through cancelling noise of an analog signal for at least one pixel and an operation method thereof by outputting a difference value between a reset voltage and a signal voltage for the at least one pixel as the analog signal for the at least one pixel.

Also, embodiments of the present invention provide a noise canceller unit cancelling noise of a digital signal which is a final output for at least one pixel and an operation method thereof by using an averaging effect by performing an oversampling operation sampling an output signal of at least one PGA for the at least one pixel a plurality of times.

### Technical Solution

A noise canceller unit included in a sensor array of a multi aperture camera includes at least one PGA (Programmable Gain Amplifier) outputting a difference value between a reset voltage for at least one pixel and a signal voltage for the at least one pixel included in the sensor array and/or a value of each of the reset voltage and the signal voltage as an analog signal for the at least one pixel; and at least one AD converter converting the outputted analog signal for the at least one pixel to a digital signal for the at least one pixel and outputting the digital signal, and the at least one AD converter performs an oversampling operation sampling an output signal of the at least one PGA for the at least one pixel a plurality of times and/or an averaging operation calculating an average value for the output signal of the at least one PGA sampled the plurality of times.

The at least one PGA may output the difference value between the reset voltage for the at least one pixel and the signal voltage for the at least one pixel and/or the value of each of the reset voltage and the signal voltage as an analog signal for the at least one pixel in order to cancel noise of the analog signal for the at least one pixel.

The at least one AD converter may output a difference value between a digital signal of the reset voltage for the at least one pixel that the analog signal of the reset voltage for the at least one pixel is converted and a digital signal of the signal voltage for the at least one pixel that the analog signal of the signal voltage for the at least one pixel is converted when the at least one PGA outputs the value of each of the reset voltage for the at least one pixel and the signal voltage for the at least one pixel as the analog signal for the at least one pixel.

The at least one AD converter may perform the oversampling operation and/or the averaging operation in order to cancel noise of the digital signal for the at least one pixel.

The at least one PGA may be formed with a single circuit performing commonly an operation outputting the reset voltage for the at least one pixel and an operation outputting the signal voltage for the at least one pixel according to switching operations of a plurality of switching elements.

The at least one PGA may amplify and output the signal voltage for the at least one pixel by controlling a capacitor value.

The at least one PGA and the at least one AD converter may be arranged for each column of the at least one pixel included in the sensor array.

An operation method of a noise canceller unit included in a sensor array of a multi aperture camera includes outputting a difference value between a reset voltage for at least one pixel and a signal voltage for the at least one pixel included in the sensor array and/or a value of each of the reset voltage and the signal voltage as an analog signal for the at least one pixel in at least one PGA (Programmable Gain Amplifier); and converting the outputted analog signal for the at least one pixel to a digital signal for the at least one pixel and outputting the digital signal in at least one AD converter, and the converting the outputted analog signal for the at least one pixel to a digital signal for the at least one pixel and outputting the digital signal includes performing an oversampling operation sampling an output signal of the at least one PGA for the at least one pixel a plurality of times and/or an averaging operation calculating an average value for the output signal of the at least one PGA sampled the plurality of times.

The outputting a difference value between a reset voltage for the at least one pixel and a signal voltage for the at least one pixel and/or a value of each of the reset value and the signal voltage as an analog signal for the at least one pixel may be outputting the difference value between the reset voltage for the at least one pixel and the signal voltage for the at least one pixel and/or the value of each of the reset voltage and the signal voltage as an analog signal for the at least one pixel in order to cancel noise of the analog signal for the at least one pixel.

The converting the outputted analog signal for the at least one pixel to a digital signal for the at least one pixel and outputting the digital signal may include outputting a difference value between a digital signal of the reset voltage for the at least one pixel that the analog signal of the reset voltage for the at least one pixel is converted and a digital signal of the signal voltage for the at least one pixel that the analog signal of the signal voltage for the at least one pixel is converted when the at least one PGA outputs the value of each of the reset voltage for the at least one pixel and the signal voltage for the at least one signal as the analog signal for the at least one pixel.

The performing an oversampling operation and/or an averaging operation may be performing the oversampling operation and/or the averaging operation in order to cancel noise of the digital signal for the at least one pixel.

The at least one PGA may be formed with a single circuit performing commonly an operation outputting the reset voltage for the at least one pixel and an operation outputting the signal voltage for the at least one pixel according to switching operations of a plurality of switching elements.

The outputting a difference value between a reset voltage for the at least one pixel and a signal voltage for the at least one pixel and/or a value of each of the reset voltage and the signal voltage as an analog signal for the at least one pixel may further include amplifying and outputting the signal voltage for the at least one pixel by controlling a capacitor value included in the at least one PGA.

The at least one PGA and the at least one AD converter may be arranged for each column of the at least one pixel included in the sensor array.

### Advantageous Effects of the Invention

According to embodiments of the present invention, a noise canceller unit improving a signal-to-noise ratio of a signal processed from at least one pixel and an operation method thereof by cancelling noise from the signal processed from the at least one signal included in a sensor array may be provided.

According to embodiments of the present invention, a high sensitivity unit through cancelling noise of an analog signal for at least one pixel and an operation method thereof by outputting a difference value between a reset voltage and a signal voltage for at least one pixel as the analog signal for the at least one pixel may be provided.

According to embodiments of the present invention, a noise canceller unit cancelling noise of a digital signal which is a final output for at least one pixel and an operation method thereof by using an averaging effect by performing an oversampling operation sampling an output signal of at least one PGA for at least one pixel a plurality of times may be provided.

### DESCRIPTION OF THE DRAWINGS

FIG. 1 is a conceptual diagram for describing a sensor array, according to an embodiment of the present invention.

FIG. 2 is a conceptual diagram for describing a noise canceller unit, according to an embodiment of the present invention.

FIG. 3 is a circuit diagram for describing at least one PGA, according to an embodiment of the present invention.

FIG. 4 is a flow chart illustrating an operation method of a noise canceller unit, according to an embodiment of the present invention.

### BEST MODE

Hereinafter, embodiments of the present invention will be described in detail with reference to the accompanying drawings. However, the present invention is not limited by the embodiments. Also, the same reference on the drawings indicates the same member.

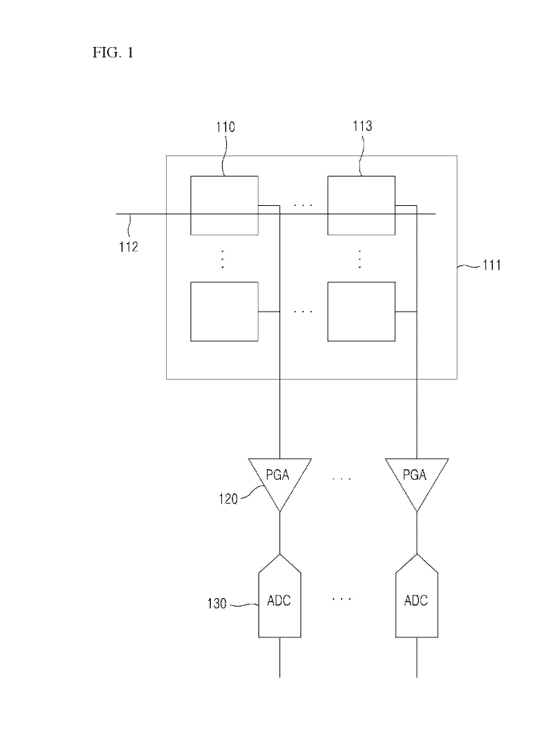

FIG. 1 is a conceptual diagram for describing a sensor array, according to an embodiment of the present invention.

Referring to FIG. 1, a sensor array includes at least one pixel 110 processing an introduced optical signal, at least one PGA (Programmable Gain Amplifier) 120 arranged for each column of the at least one pixel 110, and at least one AD converter 130.

The at least one pixel 110 forms an array 111 by forming a set consisting of a plurality of pixels. Here, the pixels consisting of the array 111 may be selected in a row unit and led. For example, pixels located in the same row among the plurality of pixels included in the array 111 may be operated simultaneously. As more particular example, when the first row 112 is operated, at least one pixel 110 and a pixel 113 located in the first low 112 which is the same with the at least one pixel 110 may be simultaneously selected and lead a pixel output after signal processing the pixel output converted to an electric signal according to the introduced optical signal through a noise canceller circuit located in the column.

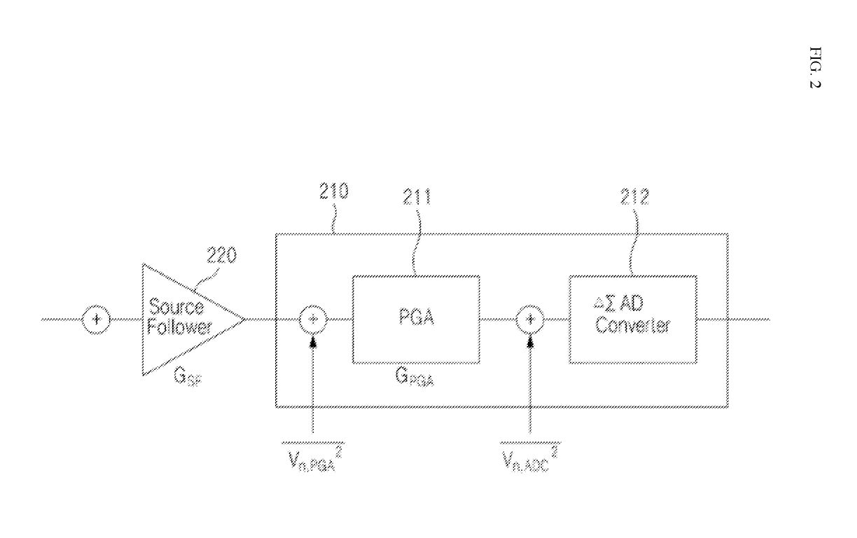

The at least one PGA 120 is connected to the at least one pixel 110 and outputs an analog signal for the at least one pixel 110 corresponding to the electric signal outputted from the at least one pixel 110. Here, the at least one PGA 120 may cancel noise of the analog signal for the at least one pixel 110 by outputting a difference value between a reset voltage for the at least one pixel 110 and a signal voltage for the at least one pixel 110 and/or a value of each of the reset voltage and the signal voltage as the analog signal for the at least one pixel 110. A detailed description related thereto will be made below referring to FIG. 2.

The at least one AD converter 130 is connected to the at least one PGA 120, and converts the analog signal for the at least one pixel 110 outputted from the at least one PGA 120 to a digital signal for the at least one pixel 110 and outputs the digital signal. Here, the at least one AD converter 130 may cancel noise of the digital signal which is a final output for the at least one pixel 110 by performing an oversampling operation sampling the output signal of the at least one PGA 120 for the at least one pixel 110 a plurality of times and/or an averaging operation calculating an average value for the output signal of the at least one PGA 120 sampled the plurality of times. Here, a Delta-Sigma AD converter may be used as the at least one AD converter 130. A detailed description related thereto will be made below referring to FIG. 2.

Likewise, the sensor array may cancel noise of the analog signal for the at least one pixel 110 by using the at least one PGA 120 and may cancel noise of the digital signal for the at least one pixel 110 by using the at least one AD converter 130 to improve a signal-to-noise ratio of the signal processed in the at least one pixel 110.

Accordingly, the sensor array may be used as a high sensitivity sensor improving a signal-to-noise ratio by cancelling noise of all output by extended applying the technology cancelling noise of the digital signal for the at least one pixel 110 to all pixels.

FIG. 2 is a conceptual diagram for describing a noise canceller unit, according to an embodiment of the present invention.

Referring to FIG. 2, a noise canceller unit 210 includes at least one PGA 211 and at least one AD converter 212. Here, the noise canceller unit 210 may be connected to an output terminal of a source follower 220 of at least one pixel.

The at least one PGA 211 is connected to the source follower 220 of the at least one pixel, and outputs a difference value between a reset voltage for the at least one pixel and a signal voltage for the at least one pixel and/or a value of each of the reset voltage and the signal voltage as an analog signal for the at least one pixel to cancel noise of the analog signal for the at least one pixel.

Here, the at least one PGA 211 may be formed with a single circuit performing commonly an operation outputting the reset voltage for the at least one pixel and an operation outputting the signal voltage for the at least one pixel according to switching operations of a plurality of switching elements.

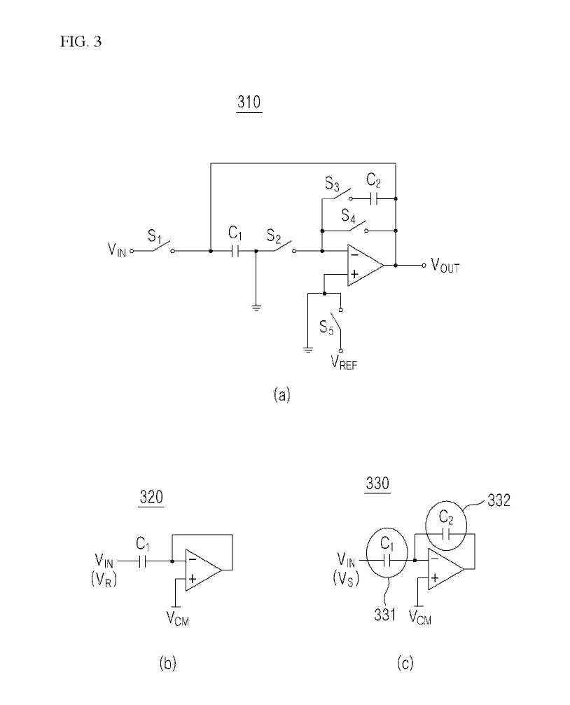

Also, the at least one PGA 211 may amplify and output the signal voltage for the at least one pixel by controlling a capacitor value. Accordingly, the at least one PGA 211 may output an amplified analog signal for the at least one pixel as well as output an analog signal for the at least one pixel that noise is canceled. A detailed description related thereto will be made below referring to FIG. 3.

Here, a noise applied to the at least one PGA 211 may be reduced in inverse proportion to a gain applied by the at least one source follower 220, and a noise applied to the at least one AD converter 212 may be reduced in inverse proportion to the gain applied by the at least one source follower 220 and a gain applied by the at least one PGA 211.

Accordingly, the noise canceller unit 210 may improve a noise reduction rate in the noise canceller unit 210 by directly connecting the at least one PGA 211 applying the gain to the output terminal of the source follower 220 of the at least one pixel which is a location before the noise is applied.

The at least one AD converter 212 is connected to the at least one PGA 211, and converts the outputted analog signal for the at least one pixel to the digital signal for the at least one pixel and outputs the digital signal.

Here, the at least one AD converter 212 performs an oversampling operation sampling an output signal of the at least one PGA 211 for the at least one pixel a plurality of times and/or an averaging operation calculating an average value for the output signal of the at least one PGA 211 sampled the plurality of times to cancel noise of the digital signal for the at least one pixel. Here, the at least one AD converter 212 may be a delta-sigma AD converter, and have an averaging effect that the average value of the output signal of the at least one PGA 211 is calculated and outputted through the oversampling operation sampling the output signal of the at least one PGA 211 the plurality of times.

For example, the at least one AD converter 212 may convert and output the digital signal by using the averaging effect by performing oversampling operation sampling the analog signal of the difference value between the reset voltage for the at least one pixel and the signal voltage for the at least one pixel outputted from the at least one PGA 211 the plurality of times.

The averaging operation may cancel noise of the output signal of the at least one AD converter 212 in reverse proportion of the plurality of times of sampling the output signal of the at least one PGA 211 for the at least one pixel.

Also, when the value of each of the reset voltage for the at least one pixel and the signal voltage for the at least one pixel is outputted as an analog signal for the at least one pixel from the at least one PGA 211, the at least one AD converter 212 may output the difference value between the digital signal of the reset voltage for the at least one pixel that the analog signal of the reset voltage for the at least one pixel is converted and the digital signal of the signal voltage for the at least one pixel that the analog signal of the signal voltage for at least one pixel as a final output.

For example, the at least one AD converter 212 may output a difference value between a digital signal of the reset voltage for the at least one pixel and a digital signal of the signal voltage for the at least one pixel as a digital signal for the at least one pixel which is a final output after converting the analog signal of the reset voltage for the at least one pixel and the analog signal of the signal voltage for the at least one pixel outputted from the at least one PGA 211 to the digital signal for the reset voltage for the at least one pixel and the digital signal voltage for the at least one pixel by using the averaging effect by performing the oversampling operation sampling each of the analog signal of the reset voltage and the analog signal of the signal voltage a plurality of times.

Likewise, the noise canceller unit 210 may improve the signal to noise ratio of the signal processed in the at least one pixel by cancelling noise of the signal processed in the at least one pixel. Accordingly, the noise canceller unit 210 may be used in the high sensitivity sensor.

FIG. 3 is a circuit diagram for describing at least one PGA, according to an embodiment of the present invention.

Referring to FIG. 3, at least one PGA 310 is formed of a circuit including a plurality of switching elements like (a).

Here, the at least one PGA 310 may be formed of a single circuit performing commonly an operation outputting a reset voltage for at least one pixel and an operation outputting a signal voltage for the at least one pixel according to switching operations of the plurality of switching elements. Here, V_IN means a signal (voltage) outputted from the at least one pixel, V_REF means a reference voltage, and V_OUT means a signal outputted from the at least one PGA 310.

For example, the at least one PGA 310 may output the reset voltage for the at least one pixel as each of the plurality of switching elements forms an equivalent circuit like (b) by turning on or off. Here, V_IN means a signal V_R that the at least one pixel is reset and outputted, and V_CM means a common mode voltage.

As another example, the at least one PGA 310 may output the signal voltage for the at least one pixel as each of the plurality of switching elements forms an equivalent circuit like (c) by turning on or off. Here, V_IN means a signal V_S that a signal is applied to the at least one pixel and outputted, and V_CM means a common mode voltage.

Here, the at least one PGA 310 may control a value of capacitor C_1 331 and C_2 332, and amplify and output the signal voltage for the at least one pixel by applying a gain to the signal voltage for the at least one pixel.

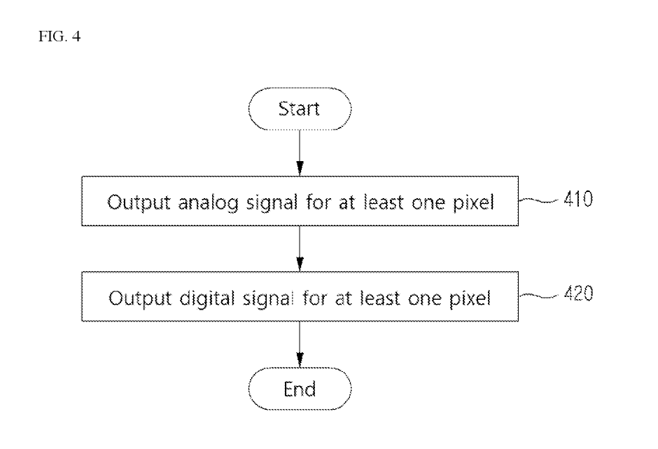

FIG. 4 is a flow chart illustrating an operation method of a noise canceller unit, according to an embodiment of the present invention.

Referring to FIG. 4, a noise canceller unit outputs a difference value between a reset voltage for at least one pixel and a signal voltage for the at least one pixel included in a sensor array in at least one PGA (Programmable Gain Amplifier) and/or a value of each of the reset voltage and the signal voltage as an analog signal for the at least one pixel 410.

Here, the noise canceller unit may output the difference value between the reset voltage for the at least one pixel and the signal voltage for the at least one pixel and/or the value of each of the reset voltage and signal voltage as the analog signal for the at least one pixel to cancel noise of the analog signal for the at least one pixel.

Also, the noise canceller unit may amplify and output the signal voltage for the at least one pixel by controlling a capacitor value included in the at least one PGA.

The at least one PGA included in the noise canceller unit performing the described operation may be formed of a single circuit performing commonly an operation outputting the reset voltage for the at least one pixel and an operation outputting the signal voltage for the at least one pixel according to switching operations of a plurality of switching elements.

Then, the noise canceller unit converts the outputted analog signal for the at least pixel to a digital signal for the at least one pixel and outputs the digital signal in at least one AD converter 420.

Here, the noise canceller unit may output the digital signal for the at least one pixel that an averaging operation is performed as a final output signal by performing an oversampling operation sampling an output signal of the at least one PGA for the at least one pixel a plurality of times and/or the averaging operation calculating an average value for the output signal of the at least one PGA sampled the plurality of times by using a delta-sigma AD converter as the at least one AD converter.

Here, the noise canceller unit may cancel noise of the digital signal for the at least one pixel by using an averaging effect calculating and outputting an average value for the output signal of the at least one PGA sampled the plurality of times by performing the oversampling operation sampling the output signal of the at least one PGA the plurality of times.

For example, the noise canceller unit may convert an analog signal of the difference value of the reset voltage for the at least one pixel and the signal voltage for the at least one pixel to a digital signal and output the digital signal by using an averaging effect by performing an oversampling operation sampling the analog signal a plurality of times in at least one AD converter.

As another example, the noise canceller unit may output a difference value between a digital signal of the reset voltage for the at least one pixel and a digital signal of the signal voltage for the at least one pixel as a digital signal for the at least one pixel which is a final output after converting the analog signal of the reset voltage for the at least one pixel and the analog signal of the signal voltage for the at least one pixel outputted from the at least one PGA to the digital signal of the reset voltage for the at least one pixel and the digital signal of the signal voltage for the at least one pixel by using the averaging effect by performing an oversampling operation sampling each of the analog signal of the reset voltage for the at least one pixel and the analog signal of the signal voltage for the at least one pixel a plurality of times in the at least one AD converter.

Likewise, the noise canceller unit may improve a signal to noise ratio of the signal processed in the at least one pixel by cancelling noise of each of the analog signal for the at least one pixel and the digital signal for the at least one pixel by including the at least one PGA and the at least one AD converter arranged for each column of the at least one pixel included in the sensor array.

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Therefore, other implements, other embodiments, and equivalents to claims are within the scope of the following claims.

1. A noise canceller unit included in a sensor array of a multi aperture camera comprising:
at least one PGA (Programmable Gain Amplifier) outputting a difference value between a reset voltage for at least one pixel and a signal voltage for the at least one pixel included in the sensor array and/or a value of each of the reset voltage and the signal voltage as an analog signal for the at least one pixel; and
at least one AD converter converting the outputted analog signal for the at least one pixel to a digital signal for the at least one pixel and outputting the digital signal,
wherein the at least one AD converter performs an oversampling operation sampling an output signal of the at least one PGA for the at least one pixel a plurality of times and/or an averaging operation calculating an average value for the output signal of the at least one PGA sampled the plurality of times.

2. The noise canceller unit of claim 1, wherein the at least one PGA outputs the difference value between the reset voltage for the at least one pixel and the signal voltage for the at least one pixel and/or the value of each of the reset voltage and the signal voltage as an analog signal in order to cancel noise of the analog signal for the at least one pixel.

3. The noise canceller unit of claim 1, wherein the at least one AD converter outputs a difference value between a digital signal of the reset voltage for the at least one pixel that the analog signal of the reset voltage for the at least one pixel is converted and a digital signal of the signal voltage for the at least one pixel that the analog signal of the signal voltage for the at least one pixel is converted when the at least one PGA outputs a value of each of the reset voltage for the at least one pixel and the signal voltage for the at least one pixel as the analog signal for the at least one pixel.

4. The noise canceller unit of claim 1, wherein the at least one AD converter performs the oversampling operation and/or the averaging operation in order to cancel noise of the digital signal for the at least one pixel.

5. The noise canceller unit of claim 1, wherein the at least one PGA is formed with a single circuit performing commonly an operation outputting the reset voltage for the at least one pixel and an operation outputting the signal voltage for the at least one pixel according to switching operation of a plurality of switching elements.

6. The noise canceller unit of claim 1, wherein the at least one PGA amplifies and outputs the signal voltage for the at least one pixel by controlling a capacitor value.

7. The noise canceller unit of claim 1, wherein the at least one PGA and the at least one AD converter are arranged for each column of the at least one pixel included in the sensor array.

8. An operation method of a noise canceller unit included in a sensor array of a multi aperture camera comprising:
outputting a difference value between a reset voltage for at least one pixel and a signal voltage for the at least one pixel included in the sensor array and/or a value of each of the reset voltage and the signal voltage as an analog signal for the at least one pixel; and
converting the outputted analog signal for at least one pixel to a digital signal for the at least one pixel and outputting the digital signal from at least one AD converter,
wherein the converting the outputted analog signal for at least one pixel to a digital signal for the at least one pixel and outputting the digital signal comprises performing an oversampling operation sampling an output signal of the at least one PGA for the at least one pixel a plurality of times and/or an averaging operation calculating an average value for the output signal of the at least one PGA sampled the plurality of times.

9. The operation method of claim 8, the outputting a difference value between a reset voltage for at least one pixel and a signal voltage for the at least one pixel included in the sensor array and/or a value of each of the reset value and the signal voltage as an analog signal for the at least one pixel outputs the difference value between the reset voltage for the at least one pixel and the signal voltage for the at least one pixel and/or the value of each of the reset voltage and the signal voltage as an analog signal for the at least one pixel in order to cancel noise of the analog signal for the at least one pixel.

10. The operation method of claim 8, wherein the converting the outputted analog signal for at least one pixel to a digital signal for the at least one pixel and outputting the digital signal outputs a difference value between a digital signal of the reset voltage for the at least one pixel that the analog signal of the reset voltage for the at least one pixel is converted and a digital signal of the signal voltage for the at least one pixel that the analog signal of the signal voltage for the at least one pixel is converted when the at least one PGA outputs a value of each of the reset voltage for the at least one pixel and the signal voltage for the at least one signal as the analog signal for the at least one pixel.

11. The operation method of claim 8, wherein the performing an oversampling operation and/or an averaging operation performs the oversampling operation and/or the averaging operation in order to cancel noise of the digital signal for the at least one pixel.

12. The operation method of claim 8, wherein the at least one PGA is formed with a single circuit performing commonly an operation outputting the reset voltage for the at least one pixel and an operation outputting the signal voltage for the at least one pixel according to switching operation of a plurality of switching elements.

13. The operation method of claim 8, wherein the outputting a difference value between a reset voltage for at least one pixel and a signal voltage for the at least one pixel and/or a value of each of the reset voltage and the signal voltage as an analog signal for the at least one pixel further comprises amplifying and outputting the signal voltage for the at least one pixel by controlling a capacitor value included in the at least one PGA.

14. The operation method of claim 8, wherein the at least one PGA and the at least one AD converter are arranged for each column of the at least one pixel included in the sensor array.
